(19) United States
(12) Patent Application Publication
(10) Pub. No.: US 2024/0058863 A1
(43) Pub. Date: Feb. 22, 2024

(54) Method for producing a machining segment

(71) Applicant: Hilti Aktiengesellschaft, Schaan (FI)

(72) Inventors: Adriana DE ANDRADE MOLERO, Chemnitz (DE); Marcel SONDEREGGER, Balgach (CH); Thorsten KLEIN, Balgach (CH); Steven MOSELEY, Nenzing-Gurtis (AT)

(21) Appl. No.: 18/267,343

(22) PCT Filed: Dec. 13, 2021
(86) PCT No.: PCT/EP2021/085471

§ 371 Date: Jun. 14, 2023

(30) Foreign Application Priority Data
Dec. 15, 2020 (EP) 20214058.8

(51) Int. Cl. B22F 7/06; B22F 10/28; B33Y 10/00

(52) U.S. Cl. CPC B22F 7/062; B22F 10/28; B33Y 10/00; B22F 2998/10

(57) ABSTRACT

A method for producing a machining segment from a first powdered matrix material and first hard material particles arranged according to a defined first particle pattern, includes: applying a powdered supporting material as a supporting layer with a melting temperature higher than the first matrix material, arranging the first hard material particles according to the defined first particle pattern in the supporting material with a depth of penetration, applying a first layer of the first matrix material to the first hard material particles and the supporting material and fusing the first layer by a powder bed fusion method, and performing a sequence of a plurality of steps N times, N≥1, wherein, in a first step of the sequence, a layer of the first matrix material is applied to the layer structure, and in a second step of the sequence, the layer of the first matrix material is fused by the powder bed fusion method and connected to the layer structure.

### TECHNICAL FIELD

The present invention relates to a method for producing a machining segment.

### BACKGROUND

Machining tools, such as core drill bits, saw blades, abrasive disks and cut-off grinding chains, comprise machining segments that are attached to a tubular, disk-shaped or annular basic body, wherein the machining segments are connected to the basic body by welding, brazing or adhesive bonding. Depending on the machining method of the machining tool, machining segments that are used for core drilling are referred to as drilling segments, machining segments that are used for sawing are referred to as sawing segments, machining segments that are used for abrasive removal are referred to as abrading segments and machining segments that are used for cut-off grinding are referred to as cut-off grinding segments.

Machining segments for core drill bits, saw blades, abrasive disks and cut-off grinding chains are produced from a matrix material and hard material particles, where the hard material particles can be randomly distributed or are arranged according to a defined particle pattern in the matrix material. In the case of machining segments with randomly distributed hard material particles, the matrix material and the hard material particles are mixed, and the mixture is poured into a suitable mold and further processed to form the machining segment. In the case of machining segments with set hard material particles, a green body is built up in layers from matrix material, in which the hard material particles are placed according to the defined particle pattern. In the case of machining segments that are welded to the basic body of the machining tool, the structure comprising a machining zone and a neutral zone has proven to be successful. The machining zone is built up from a first matrix material and the neutral zone is built up from a second matrix material, which is different from the first matrix material.

### SUMMARY OF THE INVENTION

Machining tools that are designed as a core drill bit, saw blade, abrasive disk or cut-off grinding chain and are intended for the wet machining of concrete materials are only suitable to a limited extent for the dry machining of concrete materials. In the wet machining of concrete materials, an abrasive concrete sludge is produced, which is conducive to the machining process and leads to a self-sharpening of the machining segments during the machining. The matrix material is removed by the abrasive concrete sludge and new hard material particles are exposed. In the dry machining of concrete materials, no abrasive concrete sludge that could be conducive to the machining process can form. The hard material particles quickly become dull and the machining rate drops. Due to the lack of concrete sludge, the matrix material wears too slowly and deeper-lying hard material particles cannot be exposed. In the case of known machining tools for wet machining, the matrix material and the hard material particles have similar rates of wear.

An object of the present invention is to develop an alternative method for producing a machining segment by which machining segments that are suitable for the dry machining of concrete materials can be produced. It is intended here that the machining segment should have a high machining rate and as long a service life as possible in the dry machining of concrete materials.

The method for producing a machining segment is characterized according to the invention by the steps of:
applying a powdered supporting material as a supporting layer, wherein the melting temperature of the supporting material is higher than the melting temperature of the first matrix material,
arranging the first hard material particles according to the defined first particle pattern in the supporting material, wherein the first hard material particles are arranged with a depth of penetration in the supporting material,
applying a first layer of the first matrix material to the first hard material particles and the supporting material and fusing the first layer by means of a powder bed fusion method, and
performing a sequence of a plurality of steps, which is performed N times, N≥1, wherein, in a first step of the sequence, a layer of the first matrix material is applied to the layer structure, and in a second step of the sequence, the layer of the first matrix material is fused by means of the powder bed fusion method and connected to the layer structure.

The method according to the invention for producing a machining segment is distinguished by the fact that the machining segments are built up uprightly from top to bottom, i.e. the building-up direction runs perpendicularly to the vertical direction between the underside and upper side of the machining segments. The projection of the first hard material particles on the upper side of the machining segments is created by means of the supporting material, which is different than the first matrix material. In this case, the supporting material has a melting temperature that is higher than the melting temperature of the first matrix material. Since the melting temperature of the supporting material is higher than the melting temperature of the first matrix material, the supporting material remains powdered and can be removed without problems from the finished machining segment. During the fusing of the first matrix material, the supporting material remains in its powdered state and fixes the position of the first hard material particles.

Following application, the first matrix material is fused and connected to the layer structure. Suitable methods for fusing the first matrix material are all known and future powder bed fusion methods using a laser beam or electron beam. The powder bed fusion method that is used is unimportant for the method according to the invention for producing a machining segment. What is important is that the first matrix material is fused and connected to the underlying layer structure.

The method according to the invention allows the production of machining segments that have on their upper side first hard material particles with a projection and are therefore suitable for the dry machining of concrete materials. The method according to the invention has the advantage that, upon completion of the layer structure, the finished machining segment can be removed and no further processing process in the form of sintering or hot pressing is necessary.

In a first further development, the sequence comprises an intermediate step which is performed between the first step and the second step of the sequence, wherein, in the intermediate step, second hard material particles are arranged according to a defined second particle pattern in the layer of the first matrix material. Increased wear of the first matrix material on the side surfaces of the machining segment can occur as a result of friction during machining with the machining segment. This wear can be reduced by the second hard material particles. The arrangement of the second hard material particles according to the defined second particle pattern has the advantage, compared with randomly distributed second hard material particles, that the second hard material particles can be arranged in the side surfaces and can reduce the wear on the side surfaces.

In an alternative further development, second hard material particles are admixed with the first matrix material, wherein an average particle diameter of the second hard material particles is less than an average particle diameter of the first hard material particles. Increased wear of the first matrix material on the side surfaces of the machining segment can occur as a result of friction during machining with the machining segment. This wear can be reduced by the second hard material particles.

Preferably, after the N-th sequence, at least one layer of a second matrix material is applied and fused by means of the powder bed fusion method and connected to the layer structure, wherein the second matrix material is different than the first matrix material. The second matrix material allows a neutral zone to be built up. Neutral zones are used in machining segments when the machining segments are intended to be welded to the basic body of a machining tool and the combination of first matrix material and basic body is not weldable. The second matrix material, with regard to good weldability, is selected in combination with the basic body.

Preferably, the first hard material particles have an average particle diameter and are embedded at most up to half the average particle diameter in the supporting material. The projection of the first hard material particles on the upper side of the machining segments corresponds to the depth of penetration with which the first hard material particles are embedded in the supporting material. Since the depth of penetration of the first hard material particles is at most 50% of the average particle diameter of the first hard material particles, this ensures that the first hard material particles are fixed securely in the fused first matrix material in the finished machining segment.

### BRIEF DESCRIPTION OF THE DRAWINGS

Exemplary embodiments of the invention are described hereinafter with reference to the drawing. These are not necessarily intended to show the exemplary embodiments to scale; rather the drawing, where useful for explanation, is produced in a schematic and/or slightly distorted form. It should be taken into account here that various modifications and alterations relating to the form and detail of an embodiment may be undertaken without departing from the general concept of the invention. The general concept of the invention is not limited to the exact form or the detail of the preferred embodiment shown and described hereinafter or limited to subject matter that would be restricted compared to the subject matter claimed in the claims. For given dimensioning ranges, values within the stated limits should also be disclosed as limit values and should be able to be used and claimed as desired. For the sake of simplicity, the same reference signs are used hereinafter for identical or similar parts or parts having an identical or similar function.

In the drawings:

FIGS. 1A, B show two variants of a machining tool in the form of a core drill bit;

FIGS. 2A, B show two variants of a machining tool in the form of a saw blade;

FIG. 3 shows a machining tool in the form of an abrasive disk;

FIG. 4 shows a machining tool in the form of a cut-off grinding chain;

FIG. 5 shows a machining segment which has been produced by means of the method according to the invention for producing a machining segment;

FIGS. 6A-D show the production of the machining segment of FIG. 5 by means of the method according to the invention for producing a machining segment;

FIGS. 7A, B show a green body (FIG. 7A), which is further processed to form a machining segment (FIG. 7B).

### DETAILED DESCRIPTION

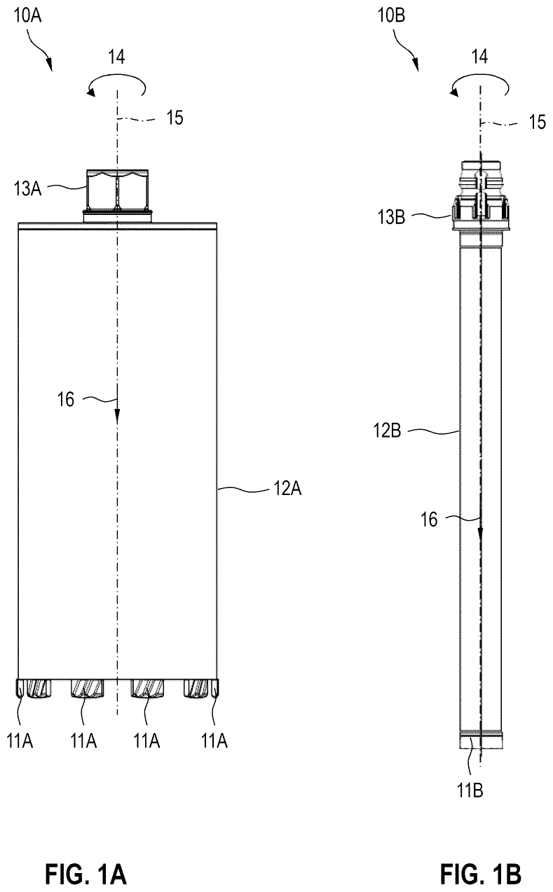

FIGS. 1A, B show two variants of a machining tool in the form of a core drill bit 10A, 10B. The core drill bit 10A shown in FIG. 1A is referred to below as the first core drill bit, and the core drill bit 10B shown in FIG. 1B is referred to as the second core drill bit; in addition, the first and second core drill bits 10A, 10B are both included under the term “core drill bit”.

The first core drill bit 10A comprises a plurality of machining segments 11A, a tubular basic body 12A and a tool fitting 13A. The machining segments 11A that are used for core drilling are also referred to as drilling segments, and the tubular basic body 12A is also referred to as a drilling shaft. The drilling segments 11A are fixedly connected to the drilling shaft 12A, for example by screwing, adhesive bonding, brazing or welding.

The second core drill bit 10B comprises an annular machining segment 11B, a tubular basic body 12B and a tool fitting 13B. The annular machining segment 11B, which is used for core drilling, is also referred to as a drilling ring, and the tubular basic body 12B is also referred to as a drilling shaft. The drilling ring 11B is fixedly connected to the drilling shaft 12B, for example by screwing, adhesive bonding, brazing or welding.

The core drill bit 10A, 10B is connected via the tool fitting 13A, 13B to a core drill and, in drilling operation, is driven by the core drill in a direction of rotation 14 about an axis of rotation 15. During the rotation of the core drill bit 10A, 10B about the axis of rotation 15, the core drill bit 10A, 10B is moved along a feed direction 16 into a workpiece to be machined, with the feed direction 16 running parallel to the axis of rotation 15. The core drill bit 10A, 10B creates a drill core and a borehole in the workpiece to be machined.

The drilling shaft 12A, 12B is of a one-piece form in the exemplary embodiment of FIGS. 1A, B, and the drilling segments 11A or the drilling ring 11B are fixedly connected to the drilling shaft 12A, 12B. Alternatively, the drilling shaft 12A, 12B may be of a two-piece form, composed of a first drilling shaft section and a second drilling shaft section, with the drilling segments 11A or the drilling ring 11B being fixedly connected to the first drilling shaft section, and the tool fitting 13A, 13B being fixedly connected to the second drilling shaft section. The first and second drilling shaft sections are connected to one another via a releasable connection device. The releasable connection device takes the form for example of a plug-and-twist connection as described in EP 2 745 965 A1 or EP 2 745 966 A1. The design of the drilling shaft as a one-piece or two-piece drilling shaft has no influence on the structure of the drilling segments 11A or of the drilling ring 11B.

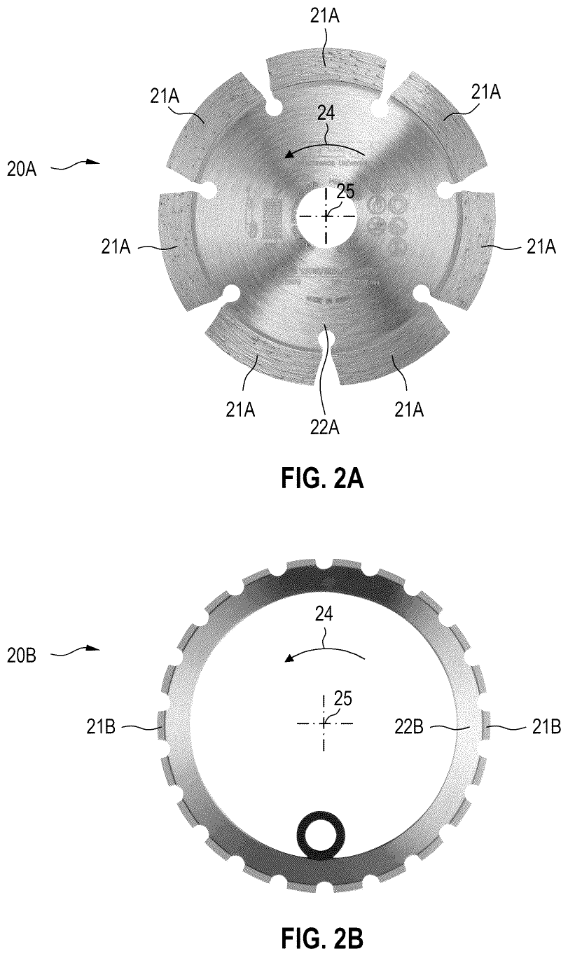

FIGS. 2A, B show two variants of a machining tool in the form of a saw blade 20A, 20B. The saw blade 20A shown in FIG. 2A is referred to below as the first saw blade and the saw blade 20B shown in FIG. 2B is referred to as the second saw blade; in addition, the first and second saw blades 20A, 20B are both included under the term “saw blade”.

The first saw blade 20A comprises a plurality of machining segments 21A, a disk-shaped basic body 22A and a tool fitting. The machining segments 21A, which are used for sawing, are also referred to as sawing segments, and the disk-shaped basic body 22A is also referred to as a blade body. The sawing segments 21A are fixedly connected to the blade body 22A, for example by screwing, adhesive bonding, brazing or welding.

The second saw blade 20B comprises a plurality of machining segments 21B, an annular basic body 22B and a tool fitting. The machining segments 21B, which are used for sawing, are also referred to as sawing segments and the annular basic body 22B is also referred to as a ring. The sawing segments 21B are fixedly connected to the ring 22B, for example by screwing, adhesive bonding, brazing or welding.

The saw blade 20A, 20B is connected to a saw via the tool fitting and, in sawing operation, is driven by the saw in a direction of rotation 24 about an axis of rotation 25. During the rotation of the saw blade 20A, 20B about the axis of rotation 25, the saw blade 20A, 20B is moved along a feed direction, with the feed direction running parallel to the longitudinal plane of the saw blade 20A, 20B. The saw blade 20A, 20B creates a sawing slit in the workpiece to be machined.

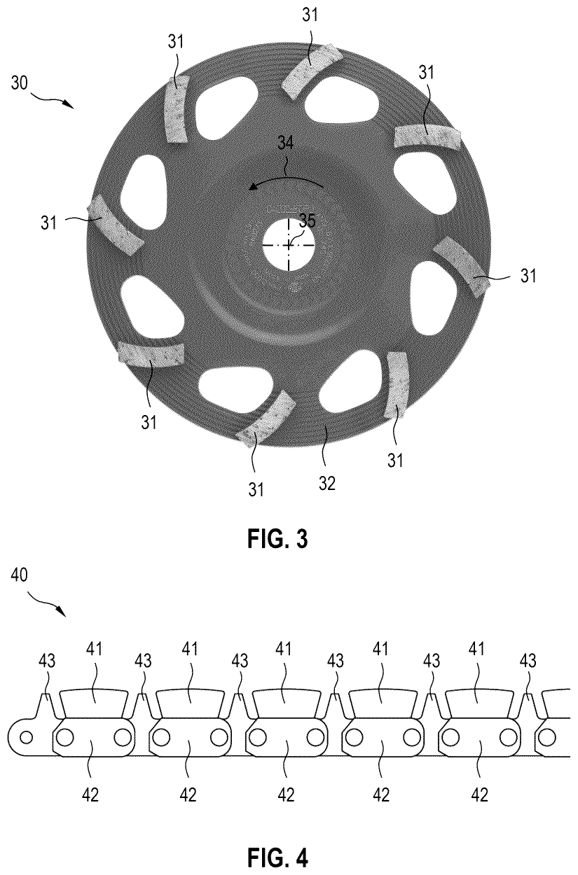

FIG. 3 shows a machining tool in the form of an abrasive disk 30. The abrasive disk 30 comprises a plurality of machining segments 31, a basic body 32 and a tool fitting. The machining segments 31, which are used for abrasive removal, are also referred to as abrading segments, and the disk-shaped basic body 32 is also referred to as a pot. The abrading segments 31 are fixedly connected to the pot 32, for example by screwing, adhesive bonding, brazing or welding.

The abrasive disk 30 is connected via the tool fitting to a tool device and, in abrading operation, is driven by the tool device in a direction of rotation 34 about an axis of rotation 35. During the rotation of the abrasive disk 30 about the axis of rotation 35, the abrasive disk 30 is moved over a workpiece to be machined, the movement running perpendicular to the axis of rotation 35. The abrasive disk 30 removes the surface of the workpiece to be machined.

FIG. 4 shows a machining tool in the form of a cut-off grinding chain 40. The cut-off grinding chain 40 comprises a plurality of machining segments 41, a plurality of basic bodies 42 in the form of links, and a plurality of connecting links 43. The machining segments 41, which are used for cut-off grinding, are also referred to as cut-off grinding segments, and the basic bodies 42 in the form of links are also referred to as driving links.

The driving links 42 are connected via the connecting links 43. In the exemplary embodiment, the connecting links 43 are connected to the driving links 42 via rivet bolts. The rivet bolts allow a rotation of the driving links 42 relative to the connecting links 43 about an axis of rotation which runs through the center of the rivet bolts. The machining segments 41 are fixedly connected to the driving links 42, for example by screwing, adhesive bonding, brazing or welding.

The cut-off grinding chain 40 is connected via a tool fitting to a tool device and, in operation, is driven by the tool device in a direction of rotation. During the rotation of the cut-off grinding chain 40, the cut-off grinding chain 40 is moved into a workpiece to be machined.

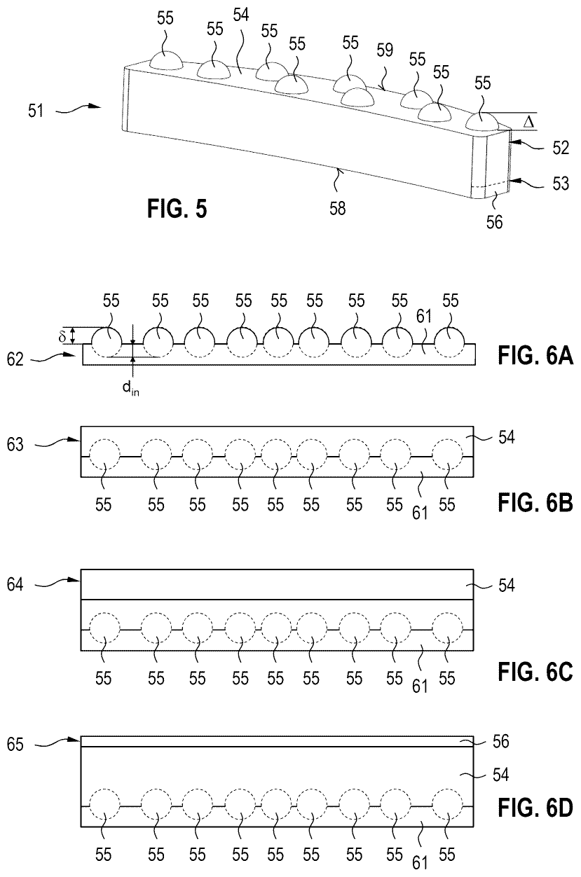

FIG. 5 shows a machining segment 51 which has been produced by means of the method according to the invention for producing a machining segment. The machining segment 51 is built up from a machining zone 52 and a neutral zone 53. The neutral zone 53 is required if the machining segment 51 is to be welded to the basic body of a machining tool and the combination of matrix material and basic body cannot be welded; in the case of weldable combinations of matrix material and basic body, there is no need for the neutral zone 53.

The machining zone 52 is built up from a powdered or granular first matrix material 54 and first hard material particles 55 which are arranged according to a defined first particle pattern, and the neutral zone 53 is built up from a powdered or granular second matrix material 56. The term “matrix material” covers all materials for building up machining segments in which hard material particles can be embedded. Matrix materials may consist of one material or be composed as a mixture of different materials. The term “hard material particles” covers all cutting agents for machining segments; these especially include individual hard material particles, composite parts made up of multiple hard material particles and coated or encapsulated hard material particles.

The machining segment 51 corresponds in structure and composition to the machining segments 11A, 21A, 21B, 31, 41; the machining segment 11B in the form of a drilling ring differs from the machining segment 51 by its annular structure. The machining segments may differ from one another in their dimensions and in the curvatures of their surfaces. The structure of the machining segments is explained on the basis of the machining segment 51 and applies to the machining segments 11A, 21A, 21B, 31, 41.

The machining segment 51 comprises the first hard material particles 55, which are arranged in the first matrix material 54. “First hard material particles” refer to those hard material particles of the machining segment 51 that machine a substrate, the number of the first hard material particles 55 and the defined first particle pattern according to which the first hard material particles 55 are arranged in the first matrix material 54 being adapted to the requirements of the machining segment 51. The first hard material particles 55 generally originate from a particle distribution which is characterized by a minimum diameter, a maximum diameter and an average diameter dₐᵥₑ.

The machining segment 51 is connected by an underside 58 to the basic body of the machining tool. In the case of machining segments for core drilling and in the case of machining segments for abrasive removal, the underside of the machining segments is generally formed as planar, whereas the underside in the case of machining segments for sawing has a curvature in order to be able to fasten the machining segments to the curved end face of the annular or disk-shaped basic body. In the case of the machining segment 51 shown in FIG. 5, the first hard material particles 55 have, on an upper side 59 opposite from the underside 58, a projection Δ with respect to the first matrix material 54.

FIGS. 6A-D show the production of the machining segment 51 by means of the method according to the invention for producing a machining segment. The machining segment 51 is built up as an upright structure from top to bottom from the first matrix material 54, the first hard material particles 55, the second matrix material 56 and a powdered supporting material 61. The supporting material 61 is different from the first matrix material 54 and serves to support the first hard material particles 55 such that these can maintain their position according to the defined first particle pattern. The supporting material 61 has a melting temperature Tₘₑₗₜ that is higher than the melting temperature T₁ of the first matrix material 54.

The machining segment 51 is produced in a plurality of steps: In a first step, a supporting layer 62 of the supporting material 61 is applied and in a second step, the first hard material particles 55 are arranged according to the defined first particle pattern in the supporting material 61, with the first hard material particles 55 being arranged with a projection δ in the supporting material 61 (FIG. 6A); the depth of penetration dᵢₙ of the first hard material particles 55 is at most 50% of the average particle diameter dₐᵥₑ of the first hard material particles 55. Since the depth of penetration dᵢₙ of the first hard material particles 55 is at most 50% of the average particle diameter, this ensures that the first hard material particles 55 are fixed securely in the first matrix material 54 in the finished machining segment 51.

In a third step, a first layer 63 of the first matrix material 54 is applied to the first hard material particles 55 and the supporting material 61 and fused by means of a powder bed fusion method (FIG. 6B). The production of the machining segment 51 is continued with a sequence of steps, wherein the sequence can be performed once or multiple times (N times with N≥1); in the exemplary embodiment, the sequence is performed once. In a first step of the sequence, a layer 64 of the first matrix material 54 is applied to the previous layer structure (FIG. 6C) and in a second step of the sequence, the layer 64 of the first matrix material 54 is fused by means of the powder bed fusion method.

Following the sequence, in a further step of the method according to the invention, a layer 65 of the second matrix material 56 is applied to the previous layer structure and fused by means of the powder bed fusion method, and in the process is connected to the previous layer structure.

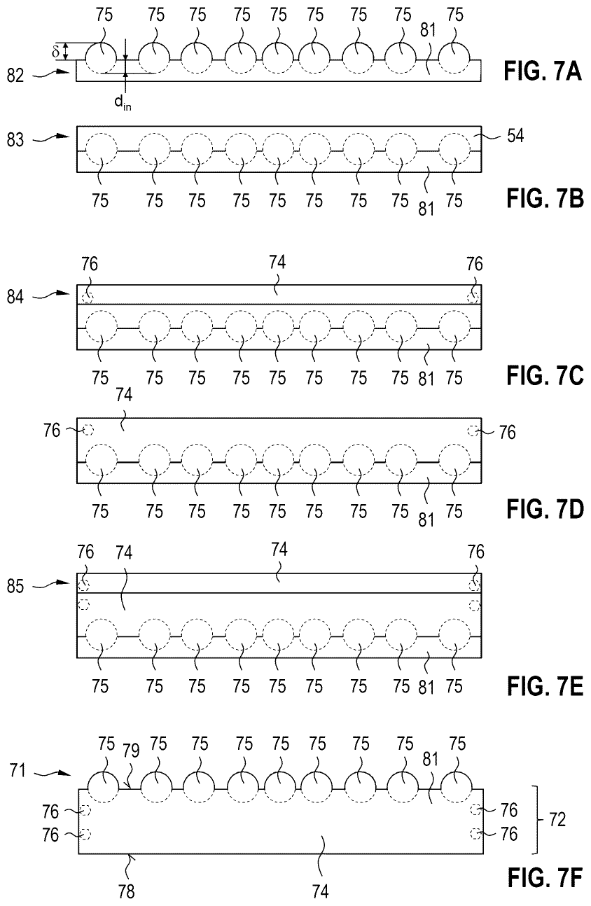

FIGS. 7A-F show another machining segment 71 which has been produced by the method according to the invention for producing a machining segment. Here, FIGS. 7A-E show the intermediate products of the machining segment 71 and FIG. 7F shows the finished machining segment 71.

The machining segment 71 differs from the machining segment 51 of FIG. 5 in that the machining segment 71 has only a machining zone 72 and no neutral zone. The machining zone 72 is built up from a powdered or granular first matrix material 74, first hard material particles 75, which are arranged according to a defined first particle pattern, and second hard material particles 76, which are arranged according to a defined second particle pattern.

Increased wear of the first matrix material 74 on the side surfaces of the machining segment 71 can occur as a result of friction with a substrate during the machining of the substrate with the machining segment 71. This wear can be reduced by the second hard material particles 76. In the machining segment 71, the second hard material particles 76 were arranged according to the defined second particle pattern in the first matrix material 74; alternatively, the second hard material particles 74 can be admixed as randomly distributed particles with the first matrix material 74.

The first hard material particles 75 and second hard material particles 76 generally originate from particle distributions which are characterized by a minimum diameter, a maximum diameter and an average diameter. In the case of the machining segment 71, the first hard material particles 75 originate from a first particle distribution with a first average diameter d_{ave,1} and the second hard material particles 76 originate from a second particle distribution with a second average diameter d_{ave,2}, the first average diameter being greater than the second average diameter. Alternatively, the first hard material particles 75 and second hard material particles 76 may originate from the same particle distribution and have the same average diameter.

The machining segment 71 is connected by an underside 78 to the basic body of a machining tool. A substrate is machined by the first hard material particles 75, which are arranged on an upper side 79 opposite from the underside 78. The machining segment 71 is built up as an upright structure from top to bottom from the first matrix material 74, the first hard material particles 75, the second hard material particles 76 and a powdered supporting material 81. The supporting material 81 is different from the first matrix material 74 and serves to support the first hard material particles 75 such that these can maintain their position according to the defined first particle pattern. The supporting material 81 has a melting temperature Tₘₑₗₜ that is higher than the melting temperature T₁ of the first matrix material 74.

The machining segment 71 is produced in a plurality of steps: In a first step, a supporting layer 82 of the supporting material 81 is applied and in a second step, the first hard material particles 75 are arranged according to the defined first particle pattern in the supporting material 81 (FIG. 7A), the first hard material particles 75 not being fully embedded in the supporting material 81 but rather having a projection δ with respect to the supporting material 81; the depth of penetration dᵢₙ of the first hard material particles 75 is at most 50% of the first average particle diameter d_{ave,1} of the first hard material particles 75. In a third step, a first layer 83 of the first matrix material 74 is applied to the first hard material particles 75 and the supporting material 81 and fused by means of a powder bed fusion method (FIG. 7B).

The production of the machining segment 71 is continued with a sequence of steps, wherein the sequence is performed once or multiple times (N times with N 1); in the case of the machining segment 71, the sequence is performed twice. In a first step of the first sequence, a layer 84 of the first matrix material 74 is applied, in an intermediate step of the first sequence, the second hard material particles 76 are arranged according to the defined second particle pattern in the layer 84 of the first matrix material 74 (FIG. 7C) and in a second step of the first sequence, the layer 84 of the first matrix material 74 is fused by means of the powder bed fusion method and connected to the previous layer structure (FIG. 7D).

In a first step of the second sequence, a further layer 85 of the first matrix material 74 is applied, in an intermediate step of the second sequence, the second hard material particles 76 are arranged according to the defined second particle pattern in the layer 85 of the first matrix material 74 (FIG. 7E) and in a second step of the second sequence, the layer 85 of the first matrix material 74 is fused by means of the powder bed fusion method and connected to the previous layer structure. After the second sequence, the machining segment 71 is complete and is removed from the supporting material 81 (FIG. 7F).

1-5. (canceled)

6. A method for producing a machining segment for a machining tool from a first powdered matrix material and first hard material particles arranged according to a defined first particle pattern, wherein the machining segment is connected by an underside to a basic body of the machining tool, the method comprising the steps of:
applying a powdered supporting material as a supporting layer, a melting temperature of the supporting material being higher than the melting temperature of the first matrix material;
arranging the first hard material particles according to the defined first particle pattern in the supporting material, the first hard material particles being arranged with a depth of penetration in the supporting material;
applying a first layer of the first matrix material to the first hard material particles and the supporting material and fusing the first layer by a powder bed fusion method, and
performing a sequence of a plurality of steps, performed N times, N≥1, wherein, in a first step of the sequence, a layer of the first matrix material is applied to the layer structure, and in a second step of the sequence, the layer of the first matrix material is fused by the powder bed fusion method and connected to the layer structure.

7. The method as recited in claim 6 wherein the sequence includes an intermediate step performed between the first step and the second step of the sequence, and in the intermediate step, second hard material particles are arranged according to a defined second particle pattern in the layer of the first matrix material.

8. The method as recited in claim 6 wherein second hard material particles are admixed with the first matrix material, an average particle diameter of the second hard material particles being less than an average particle diameter of the first hard material particles.

9. The method as recited in claim 6 wherein, after the N-th sequence, at least one layer of a second powdered matrix material is applied and fused by the powder bed fusion method and connected to the layer structure, the second matrix material being different than the first matrix material (54).

10. The method as recited in claim 6 wherein the first hard material particles have an average particle diameter and are embedded at most up to half the average particle diameter in the supporting material.
